(19) United States
(12) Patent Application Publication
(10) Pub. No.: US 2015/0077561 A1
(43) Pub. Date: Mar. 19, 2015

(54) MONITORING A BACK ROW SEAT AREA OF A VEHICLE

(71) Applicant: Toyota Motor Sales, U.S.A., Inc., Torrance, CA (US)

(72) Inventor: Jason A. Schulz, Redondo Beach, CA (US)

(21) Appl. No.: 14/333,638

(22) Filed: Jul. 17, 2014

Related U.S. Application Data
(63) Continuation-in-part of application No. 14/175,862, filed on Feb. 7, 2014.
Application No. 14/175,862 is a continuation of application No. 14/180,563, filed on Feb. 14, 2014.
(60) Provisional application No. 61/878,898, filed on Sep. 17, 2013.
(60) Provisional application No. 61/878,898, filed on Sep. 17, 2013.

(51) Int. Cl. B60N 2/00; B60R 11/04; G06F 3/041

(52) U.S. Cl. CPC B60N 2/002; G06F 3/0416; B60R 11/04; B60R 2300/8006
USPC 348/148

(57) ABSTRACT

A back row monitoring system for a vehicle disclosed includes a display upon which imagery of at least a portion of a back row seat area of a vehicle can be displayed. The imagery can be captured by an imagery sensor. The back row monitoring system can detect one or more biometric markers from one or more passengers located in the back row seat area. The detected biometric markers, or a portion thereof, can be displayed on the display. The displayed biometric markers can be overlaid on the imagery. The back row monitoring system can also enable a user to pause currently playing audio and/or video from a vehicle infotainment system such that the driver can communicate to one or more passengers in the back row area through the infotainment system.

### CROSS-REFERENCE TO RELATED APPLICATIONS

This application is a Continuation In Part of U.S. patent application Ser. No. 14/175,862, filed 7 Feb. 2014, and U.S. patent application Ser. No. 14/180,563, filed 14 Feb. 2014, each of which claims priority to U.S. Provisional Patent Application Ser. No. 61/878,898, filed 17 Sep. 2013, each of which is incorporated herein by reference in its entirety.

### BACKGROUND

The present disclosure relates to a vehicle and more particularly to monitoring at least a portion of a back row of a vehicle.

Presently, vehicle dash cams are cameras that are placed on a vehicle's dashboard or windshield to record video of front and side areas of the vehicle. Some vehicles, such as police vehicles, also include cameras to continuously record video of prisoner areas in a vehicle. Such video may be later manually accessed to review the recorded events.

### SUMMARY

Disclosed herein is a back row monitoring system for a vehicle which includes a display operable to display imagery of at least a portion of a back row seat area. Data from one or more biometric markers detected from one or more back row passengers can be overlaid thereon. The back row monitoring system may be used in any type of vehicle.

A method of back row monitoring for a vehicle, according to one disclosed non-limiting embodiment, includes detecting at least one biometric marker of one or more passengers located in a back row seat area of the vehicle. The method also includes displaying imagery of at least a portion of the back row seat area. The method further includes displaying data from the detected at least one biometric marker. In one or more arrangements, the data from the detected at least one biometric marker can be overlaid on or proximate to the imagery.

A back row monitoring system for a vehicle, according to another disclosed non-limiting embodiment, includes a sensor system. The sensor system can be operable to capture imagery of at least a portion of a back row seat area within the vehicle. The sensor system can also be operable to detect and/or identify at least one biometric marker of one or more passengers located in the back row seat area. A display system is operable to display the captured imagery of at least a portion of the back row seat area. Data from the detected at least one biometric marker can be presented on the display. Such data can be overlaid on or proximate the imagery

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic of an example vehicle for use with a back row monitoring system;

FIG. 2 is a flow chart illustrating an example of a back row monitoring system according to one disclosed non-limiting embodiment; and

FIG. 3 is a flow chart illustrating an example of a back row monitoring system according to another disclosed non-limiting embodiment; and

FIG. 4 is an example of a display system presenting imagery of at least a portion of a back row seat area of a vehicle and biometric marker data of a passenger location in the back row seat area.

### DETAILED DESCRIPTION

This application generally relates to a back row monitoring system and computer implemented method for a vehicle. The back row monitoring system can capture and display imagery of at least a portion of a back row seat area of the vehicle. The back row monitoring system can also detect, analyze and/or identify at least one biometric marker of one or more passengers located in the back row seat area. The back row monitoring system can also display data from the detected at least one biometric marker from one or more of the back row passengers. As an example, the data can be overlaid on the displayed imagery or located proximate thereto. The biometric markers can be analyzed to identify a condition or state of a passenger located in the back row seat area. For instance, one of the biometric markers can be a temperature of the passenger. The data can be displayed in a manner to facilitate understanding of the data and/or the significance of the data, such as via color-coding, flashing, highlighting, offsetting, etc. The back row monitoring system can also interpolate, extrapolate, analyze and/or otherwise process the data to provide information about one or more of the back row passengers. For instance, a status of a back row passenger can be determined at least in part by analyzing the detected biometric markers. For example, one or more biometric markers may individually or collectively indicate that a passenger is sleeping. In such case, the back row monitoring system can display such information in any suitable manner, such as “Passenger Sleeping”. The back row monitoring system can also permit a front row passenger to observe and record activities occurring in the back row seat area of the vehicle.

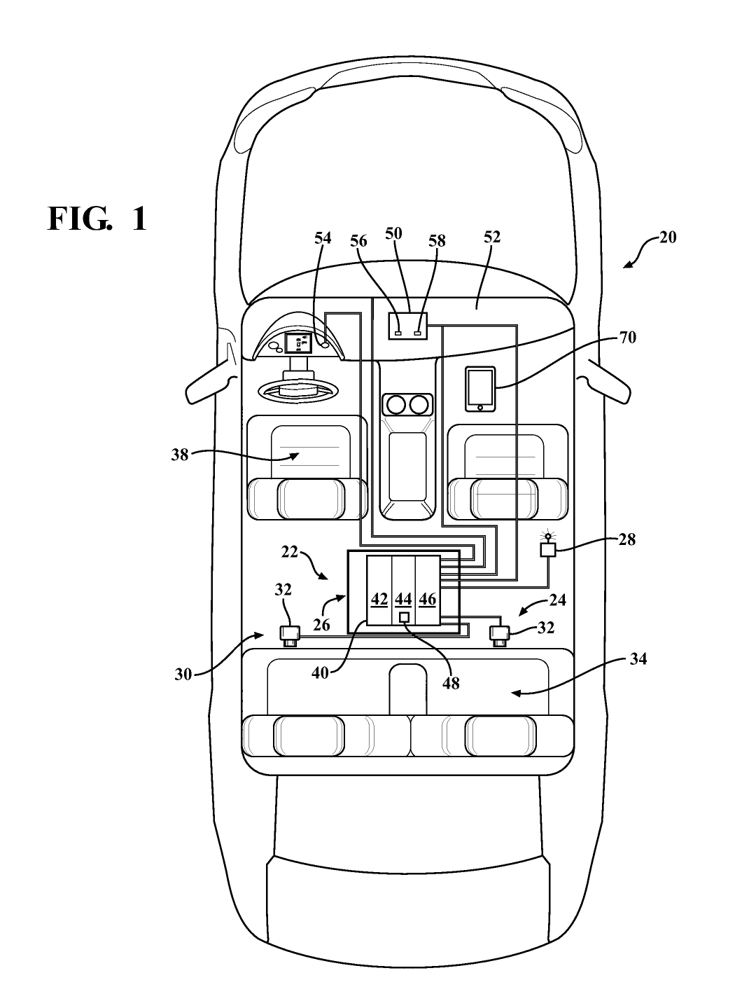

FIG. 1 schematically illustrates a vehicle 20 with a back row monitoring system 22. While FIG. 1 shows the vehicle 20 as being an automobile, it will be understood that embodiments are not limited to automobiles. In some implementations, the vehicle may be a watercraft, an aircraft or any other form of mechanized transport. The back row monitoring system 22 generally includes a back row sensor system 24, a control system 26 and a communication system 28. It should be appreciated that although particular systems are separately defined, each or any of the systems or portions thereof may be otherwise combined or segregated via hardware and/or software.

The systems 24, 26, 28 can be communicatively linked in any suitable manner, such as through one or more communication networks. As used herein, the term “communicatively linked” can include direct or indirect connections through a communication channel or pathway or another component or system. A “communication network” means one or more components designed to facilitate the delivery of information from one source to another.

The one or more communication networks can be configured to communicate via a wireless and/or wired medium. The one or more communication networks can be implemented as, or include, without limitation, a wide area network (WAN), wireless wide area network (WWAN), a local area network (LAN), a personal area network (PAN) (e.g. IRDA, wireless USB, ZigBee network, body area network or near field communication network), wireless local area network (WLAN), the Internet, the Public Switched Telephone Network (PSTN), a wireless network, a mobile network, a Virtual Private Network (VPN), the Internet, and/or one or more intranets. The communication network(s) can include any combination of the above networks and/or other types of networks. The communication network(s) can include one or more routers, switches, access points, wireless access points, and/or the like.

The back row sensor system 24 is operable to detect and/or identify a condition or state within the vehicle 20 via a vehicle interior sensor system 30. The vehicle interior sensor system 30 includes an imagery sensor 32 operable to capture imagery of at least a portion a back row seat area 34 of the vehicle. Such imagery can include one or more passengers located in the back row seat area 34. The imagery sensor 32 can be any device, component, system or means that can capture imagery. Examples of the imagery sensor 32 include, but are not limited to, cameras, an area array sensor, closed-circuit television cameras, charge coupled devices (CCD), imaging infrared systems, thermal imaging systems, light amplification systems, complementary metal oxide semiconductors (CMOS), linear array sensors and combinations thereof that generate imagery for communication to the control system 26.

“Back row seat area” means any seating area of a vehicle located behind the driver's seat of the vehicle. In one or more arrangements, a vehicle can have one or more back row seating areas. For instance, a van, mini-van or bus may have a plurality of back row seating areas.

Imagery captured by the imagery sensor 32 can be processed and/or analyzed by one or more components of the back row monitoring system 22, such as by the control system 26. Any suitable processing and/or analysis can be performed on the imagery. For instance, in one disclosed non-limiting embodiment, the control system 26 can be configured to analyze imagery from the imagery sensor 32 to determine a skeletal joint relationship to determine the location and/or movements of one or more of the passengers in the back row seat area 34, such as interactions with one or more other passengers in the back row seat area 34. Given that the vehicle occupants are typically seated and belted, multi-point skeletal joint relationships and facial recognition map data can provide a relatively accurate position of each occupant on an XYZ axis map that can track, to a desired level of precision, the state of each passenger.

Other internal sensors 30 include a biometric marker sensor 36 operable to capture, detect, collect, accept and/or receive a biometric marker of one or more passengers in the back row seat area 34 to permit identification of a state or condition of the one or more passengers. A “biometric marker” is any data related to physiological, behavioral, biological or other characteristics that indicate or suggest a state or condition of a living entity. Examples of biometric markers include, but are not limited to, heart rate, skin temperature, eye movements, sudden bodily movements, respiration, perspiration, speech or sound patterns, and/or other biometric markers. The biometric marker sensor 36 can generate and/or collect data associated with the detected at least one biometric markers. Such data can be communicated to the control system 26 in any suitable manner. The control system 26 can be configured to analyze and/or process such data and/or the biometric markers. The data and/or the biometric markers may be analyzed and/or otherwise processed by the control system 26 to, for example, determine a state or condition of one or more passengers in the back row seat area 23.

The control system 26 generally includes a control module 40 with a processor 42, a memory 44, and an interface 46. The control module 40 may be a portion of a central vehicle control, a stand-alone unit, a cloud-based system, or other system. The processor 42 can be any component or group of components that are configured to execute any of the processes described herein. The processor 42 may be implemented with one or more general-purpose and/or special-purpose processors having desired performance characteristics. Examples of suitable processors 42 include microprocessors, microcontrollers, DSP processors, and other circuitry that can execute software.

The memory 44 may include any type of computer-readable medium that stores the data and control algorithms 48 described herein below. Other operational software for the processor 42 may also be stored in the memory 44. The memory 44 can include volatile and/or non-volatile memory. Examples of suitable memory 44 may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 44 can be operatively connected to the processor 42 for use thereby. The term “operatively connected” can include direct or indirect connections, including connections without direct physical contact.

The interface 46 can facilitate communication between the back row sensor system 24, the communication system 28 and other on board and/or off board vehicle systems, including, for example, a touch screen display 50 in an interface 52 (e.g. a vehicle-human machine interface). The interface 52 can be located in a front row seat area 38 of the vehicle, as is shown in FIG. 1.

The display 50 can be any suitable type of display. In one or more arrangements, the display 50 can be a touch screen display or a multi-touch display. The touch screen can allow a user to engage or interact with one or more displayed elements, such as a graphical user interface (GUI), and/or other applications running on any vehicle system, including any of those described herein, through contact with the display 50. For example, a user may make selections and move a cursor by simply touching the display 50 via a finger or stylus.

The back row sensor system 24 is operable to capture and/or store imagery of at least a portion of the back row seat area 34. The imagery can be stored in any suitable device, system, component or means, including, for example, the memory 44, one or more databases and/or one or more data storage devices. In one or more arrangements, various predefined time periods of the imagery may be stored. For example, the predefined time period can be thirty minutes in a continuous loop. However, it will be understood that other time periods are possible. In some implementations, the time period can be defined by a user of the vehicle. Alternatively, the back row sensor system 24 can include storage for recordation of imagery from the back row sensor 32. In one or more arrangements, imagery captured by the imagery sensor 32 may be displayed in real time on the display 50. The imagery can be captured and/or presented in any suitable form, including, for example, as video and/or as one or more still images.

The display 50 can enable interaction and control of the back row monitoring system 22 as well as other on board vehicle systems, such as a vehicle infotainment system 54. In one disclosed non-limiting embodiment, a control 56 may be activated to pause the infotainment system 54 and/or to allow the driver to speak through the infotainment system 54. That is, the driver can speak to the passengers located in the back row seat area 34 while the currently playing audio and/or video from the vehicle infotainment system 54 is paused in response to activation of the control 56. In one or more arrangements, the control 56 can be provided as a GUI, such as a button, on the display 50.

Imagery captured by the back row sensor system 24 can be stored in the memory 44, or other suitable database or data storage device. A “REPLAY” control 58 provided on the interface 52, or as a GUI on the display 50. The control 58 is operable to allow a user to selectively tag a portion of the captured imagery.

In one or more arrangements, the control 58 can enable a user to selectively tag at least a portion of the captured imagery for later review. In some instances, the tagging can include the most recently captured imagery. In some instances, the tagging can be for a predefined amount of time of imagery. For instance, the control 58 can enable a user to selectively tag the most recent five minutes of imagery. The predefined amount of time can be an amount of time before an input for tagging is received and/or an amount of time after an input for tagging is received. “Tag” means selectively storing a portion of the imagery for later review. It should be appreciated that the tagged imagery portion may be stored in the memory 44, one or more databases and/or one or more data storage devices. The tagged imagery can be stored while the continuous loop of imagery may continue to provide continuous monitoring of the back row seat area 34.

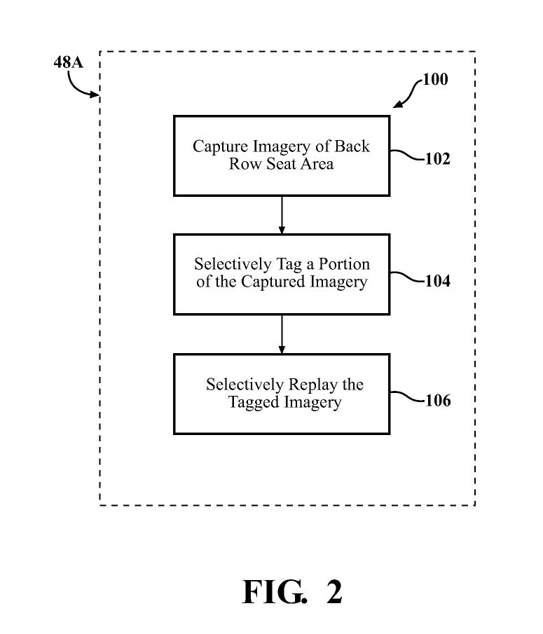

With reference to FIG. 2, in one disclosed non-limiting embodiment, an algorithm 48A for operation of the back row monitoring system 22 is schematically illustrated. The functions of the algorithm 48A are disclosed in terms of functional block diagrams. It should be appreciated that these functions may be enacted in dedicated hardware circuitry, or programmed software routines or instructions on a computer-readable storage medium, capable of execution as instructions in a microprocessor-based electronics control embodiment such as the control system 26.

The algorithm 48A provides a method 100 of monitoring at least a portion of the back row seat area 34 of a vehicle. At step 102, imagery of the back row seat area 34 can be captured. For instance, the back row sensor 32 of the back row sensor system 24 can capture imagery of at least a portion of the back row seat area 34. In one or more implementations, the captured imagery can be stored. At step 104, a portion of the imagery can be selectively tagged by a user. For instance, in response to, for example, an action or activity of a passenger in the back row seat area 34, a driver or front row passenger in a front row seat area 38 (FIG. 1) can activate the back row sensor system 24 to tag a portion of the imagery by activation of the control 58. The tagged portion of the imagery can be stored.

At step 106, the tagged imagery may be selectively replayed on the display 50 or on a personal electronic device 70 such as a portable computer (e.g. a laptop, a tablet or the like), mobile telephone, smart phone, a smart watch, smart eyeglasses, wireless-enabled personal digital assistant and/or a wearable device. The personal electronic device 70 may be communicatively linked with the back row monitoring system 22 in any suitable manner, such as through the communication system 28 and/or one or more communication networks.

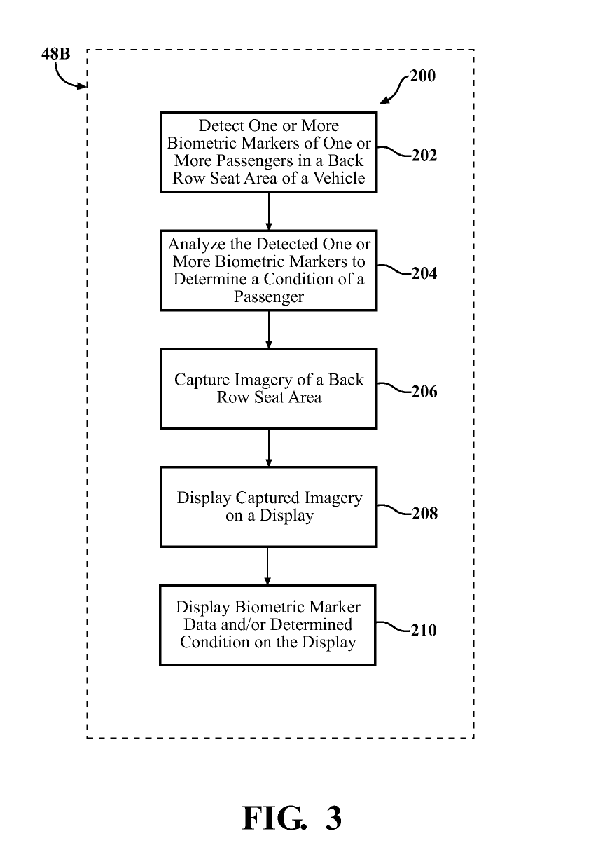

With reference to FIG. 3, in another disclosed non-limiting embodiment, an algorithm 48B for operation of the back row monitoring system 22 is schematically illustrated. The functions of the algorithm 48B are disclosed in terms of functional block diagrams. It should be appreciated that these functions may be enacted in dedicated hardware circuitry, or programmed software routines or instructions on a computer-readable storage medium, capable of execution as instructions in a microprocessor-based electronics control embodiment such as the control system 26.

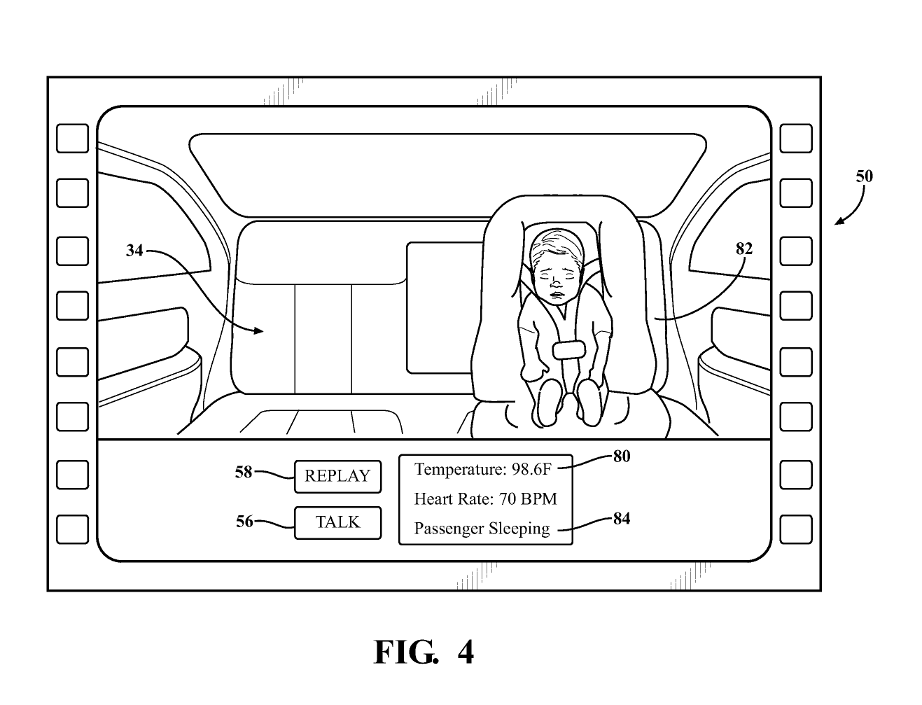

The algorithm 48B provides a method 200 to monitor at least a portion of the back row seat area 34 of a vehicle. At step 202, one or more biometric markers of one or more passengers in the back row seat area 34 can be detected. At step 204, the detected one or more biometric markers can be analyzed to determine a condition of a passenger in the back row seat area 34. At step 206, imagery of at least a portion of the back row seat area 34 can be captured. At step 208, imagery 82 of at least a portion of the back row seat area 34 can be displayed on the display 50 (FIG. 4). At step 210, at least some of the one or more detected biometric markers and/or a determined condition can be displayed on the display 50. For example, as is shown in FIG. 4, biometric marker data 80 (e.g. a temperature of a passenger in the back row seat area 34) can be presented on the display 50. The biometric marker data 80 can be overlaid onto the imagery 82 of the passenger on the display 50 or can be presented proximate thereto. The biometric marker data 80 may be further displayed in a manner to facilitate understanding of the data and/or the significance of the data, such as via color-coding, flashing, highlighting, offsetting, etc. In one or more arrangements, information 84 (e.g. a state or condition) determined by analyzing the detected biometric markers can be displayed on the display 50. For instance, an indication such as “Passenger Sleeping” can be displayed based, for example, on one or more of the detected biometric markers (e.g. heart rate and/or eye movement). That is, the detected biometric marker data 80 may be analyzed or otherwise processed to make determinations with regard to a state or condition of the passenger. Such state or condition may not be not specifically measured.

Furthermore, arrangements described herein may take the form of a computer program product embodied in one or more computer-readable media having computer-readable program code embodied, e.g., stored, thereon.

Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments presented herein are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A method of back row monitoring for a vehicle, comprising:
detecting a biometric marker of a passenger seated in a back row seat area of the vehicle;
displaying imagery of at least a portion of the back row seat area on a display; and
displaying the detected biometric marker on the display.

2. The method as recited in claim 1, wherein detecting a biometric marker of a passenger seated in a back row seat area of the vehicle includes detecting at least one of a heart rate, a skin temperature, an eye movement, and a sudden bodily movement of a passenger seated in a back row seat area of the vehicle.

3. The method as recited in claim 1, wherein the detected biometric marker is overlaid on the displayed imagery of at least a portion of the back row seat area.

4. The method as recited in claim 1, further comprising recording the imagery of the back row seat area.

5. The method as recited in claim 4, wherein the recording is performed as a continuous loop.

6. The method as recited in claim 5, further comprising selectively tagging at least a portion of the recorded imagery for later review.

7. The method as recited in claim 6, wherein the selectively tagging includes storing the at least a portion of the recorded imagery for later review.

8. The method as recited in claim 6, further comprising communicating the at least a portion of the recorded imagery for later review to a personal electronic device.

9. The method as recited in claim 6, wherein the selectively tagging is effectuated through a touch screen.

10. The method as recited in claim 4, further comprising communicating the at least a portion of the recorded imagery for later review to a display on a human-machine interface.

11. The method as recited in claim 6, wherein the selectively tagging is effectuated through a touch screen on a human-machine interface and the at least a portion of the recorded imagery for later review is displayable on the touch screen.

12. The method as recited in claim 1, further comprising selectively muting an infotainment system in the back row seat area.

13. The method as recited in claim 1, further comprising selectively pausing an infotainment system in the back row seat area.

14. The method as recited in claim 13, further comprising selectively providing audio communication with the back row seat area from a driver area through the infotainment system.

15. A back row monitoring system for a vehicle, comprising:
an imagery sensor operable capture imagery of at least a portion of a back row seat area of the vehicle;
a biometric sensor operable to detect a biometric marker of a passenger seated in the back row seat area of the vehicle; and
a display system operatively connected to the imagery sensor, the display system operable to display thereon imagery captured by the imagery sensor, and the display system operatively connected to the biometric sensor to display the detected biometric marker.

16. The system as recited in claim 15, further comprising:
a control system operatively connected to the imagery sensor and the biometric sensor, the control system operable to record a predetermined time period of the imagery as a continuous loop recording; and
a replay control operatively connected to the control system to enable selective tagging of at least a portion of the continuous loop recording.

17. The system as recited in claim 16, wherein the display system includes a touch screen, and wherein one or more user interface elements associated with the replay control are presented on the touch screen.

18. The system as recited in claim 16, wherein the control system includes a memory, and wherein the portion of the continuous loop recording is stored in the memory.

19. The system as recited in claim 15, wherein at least a portion of the detected biometric marker that is displayed on the display system is color-coded.

20. The system as recited in claim 15, wherein the control system is configured to process the detected biometric marker to determine information to display on the display system.
